(19) United States
(12) Patent Application Publication
(10) Pub. No.: US 2004/0268003 A1
(43) Pub. Date: Dec. 30, 2004

(54) Method and apparatus for providing signal functionality

(76) Inventor: Ken Nicholas, Tomball, TX (US)

Correspondence Address: HEWLETT-PACKARD COMPANY, Intellectual Property Administration, P.O. Box 272400, Fort Collins, CO, 80527-2400, US

(21) Appl. No.: 10/602,518

(22) Filed: Jun. 24, 2003

(51) Int. Cl. G06F 13/00

(52) U.S. Cl. 710/303; 710/305

(57) ABSTRACT

A control circuit is adapted to receive a plurality of signals, each of the plurality of signals adapted to perform a separate respective function, and to combine the plurality of signals into a single signal adapted to perform each of the separate respective functions. For example, a device having a first type of processor is adapted to produce a plurality of signals, wherein each of the plurality of signals is produced for a different purpose, and having a circuit adapted to combine the plurality of signals into a single signal adapted to accomplish each different purpose. A coupling device is adapted to connect the device to another device, the coupling device having a connector adapted to receive the single signal but not the plurality of signals.

### BACKGROUND OF THE RELATED ART

Integrated circuit devices, such as microprocessors, may deliver electrical signals to and receive electrical signals from other integrated circuit devices. Integrated circuit devices operate based upon the delivery and/or receipt of the correct electrical signals at appropriate times. However, as microprocessors and other integrated circuits evolve, signal requirements often change. As a result, if the signal requirements for any integrated circuit in an electronic device change, other portions of the device are typically redesigned to ensure proper compatibility and functionality. Such redesign can be costly and time consuming.

### SUMMARY

In accordance with one aspect of the present invention, there is provided a control circuit adapted to receive a plurality of signals. Each of the plurality of signals adapted to perform a separate respective function. The control circuit is adapted to combine the plurality of signals into a single signal adapted to perform each of the separate respective functions.

In accordance with another aspect of the present invention, there is provided a system comprising a device having a first type of processor adapted to produce a plurality of signals. Each of the plurality of signals is produced for a different purpose. The device includes a circuit adapted to combine the plurality of signals into a single signal adapted to accomplish each different purpose. The system comprises a coupling device adapted to connect the device to another device. The coupling device has a connector adapted to receive the single signal but not the plurality of signals.

### BRIEF DESCRIPTION OF THE DRAWINGS

Exemplary embodiments of the invention are apparent upon reading the following detailed description with reference to the drawings in which:

FIG. 1 illustrates a block diagram of a processor-based electronic device or system in accordance with an embodiment of the present invention;

FIG. 2 illustrates a portable device with a docking station and connection ports in accordance with an embodiment of the present invention; and

FIG. 3 illustrates a block diagram of a simplified signal path in accordance with an embodiment of the present invention.

### DESCRIPTION OF SPECIFIC EMBODIMENTS

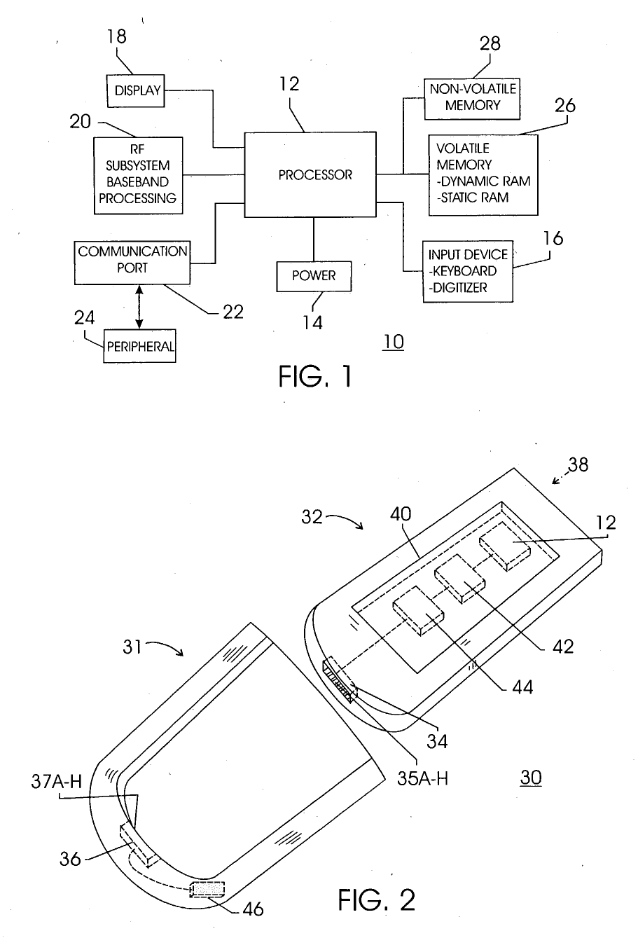

Referring initially to FIG. 1, a block diagram of a processor-based electronic device or system, generally designated by reference numeral 10, is illustrated. The system 10 may be any of a variety of types such as a computer, pager, cellular phone, personal organizer, control circuit, or the like, and the system typically includes a number of various types of integrated circuit devices. In one particular example, the system 10 may comprise a pocket PC, such as an iPAQ available from the Hewlett-Packard Company.

In the system 10, a processor 12, such as a microprocessor, may control the operation of system functions. The processor 12 may be coupled to various types of memory devices to facilitate operation. For example, the processor 12 may be connected to a volatile memory 26 and a non-volatile memory 28. The non-volatile memory 26 may comprise a variety of memory types, such as static random access memory (“SRAM”) or dynamic random access memory (“DRAM”) or the like. The non-volatile memory 28 may comprise various types of memory such as electrically programmable read only memory (“EPROM”), and/or flash memory, or the like

The system 10 may include a power supply 14 that may comprise a battery or batteries, an AC power adapter, and/or a DC power adapter. Various other devices may be coupled to the processor 12 depending on the functions of the system 10. For example, one or more input devices 16 may be coupled to the processor 12 to receive input from a user. The input device 16 may comprise a user interface and may include buttons, switches, a keyboard, a light pen, a mouse, a digitizer and/or a voice recognition system or the like. An audio or video adapter and display 18 may also be coupled to the processor 12 to provide information to the user.

A communications port 22 may be adapted to provide a communication interface between the electronic device 10 and one or more peripheral devices 24. The peripheral devices 24 may include a docking station, expansion bay, or other external component. Furthermore, an RF sub-system/baseband processor 20 may be coupled to the processor 12 to provide wireless communication capability.

Portable electronic devices, such as pocket PCs, offer many of the benefits of larger systems along with the added convenience of small size and light weight. However, it is often desirable to couple portable electronic devices to a larger system, such as a desktop computer, to provide data synchronization and/or enhanced functionality. In keeping with the example of a portable electronic device, FIG. 2 illustrates a portable device 32 with a docking station 31 in accordance with an embodiment of the present invention. In FIG. 2, a portable device 32 and a docking station 31 are both generally referred to by the reference numeral 30 and may generally correspond to the system 10 of FIG. 1.

To facilitate communication between the portable device and a larger system, the portable device 32 may comprise a connection port 34, and the docking station 31 may comprise a connection port 36 that may be adapted to couple with the connection port 34. The docking station 31 may include a docking component 46 that may facilitate connection of the docking station, and thus the portable device 32, to external peripheral devices, for example. In this example, the portable device 32 may be engaged with the docking station 31 by sliding the portable device 32 into the docking station 31 as indicated by the arrow 38 until the connection port 34 engages with the connection port 36, although other engagement techniques could be used as well.

When connected to the docking station 31, the portable device 32 may be able to transfer information to the docking station 31 through physical connections formed between the connection port 34 of the portable device 32 and the connection port 36 of the docking station 31. The physical connections may be provided by a plurality of electrical pins 35A-H disposed within the connection port 34 and a corresponding plurality of electrical pins 37A-H disposed within the connection port 36.

Each of the pins 35A-H and the corresponding pins 37A-H may be implemented to exchange specific signals that may be provided between the internal components of the portable device 32 and the docking station 31. For example, certain pins 35A-H and corresponding pins 37A-H may be mapped to specific connection paths to transmit and/or receive certain electrical signals from the processor 12. In this manner, electrical signals may be delivered from the processor 12 (possibly through intervening circuitry, such as a buffer 42 and a logic component 44, on a circuit board 40) to the connection ports 34 and 36.

The portable device 32 may not function properly if the signal configuration of one of the internal components of the portable device 32 is altered. For example, if the signal configuration of the processor 12 is changed, such as in a newer version of the processor, the processor 12 may be incompatible or may not function correctly with other portions of the system that may have been designed for previous versions of the processor 12. This incompatibility may exist because the expected signals are not produced by the new processor 12 on the same pins or in the same manner as the previous version of the processor 12. For example, if the signal configuration of the processor 12 is changed, signals such write strobes, write enable signals (nWE), PCMCIA write enable signals (nPWE), or other operational signals may not have the same functionality or may be delivered to the wrong pins of the connection port 34. Miscommunication or communication failure between the portable device 32, the docking station 31, and/or peripheral devices connected thereto may result.

For example, in one version of the processor 12, a single signal may be used to perform two functions, while in another version of the processor 12 one signal may be used to perform one of the functions and another signal may be used to perform the other of the functions. For example, if the processor 12 is an Intel SA-1110 microprocessor, the processor's expansion bus provides expansion bus address spaces to be configured as either variable latency I/O (VLIO) or static memory. Writes to the address space in either configuration use the nWE signal as a write strobe. Thus, the expansion connectors 32 and 34 of the device 30 are designed to receive the nWE signal at a fixed pin location.

To carry on with this example, the Intel PXA250 and PXA255 microprocessors are successors to the SA-1110 microprocessor. Unlike the SA-1110 processor, which uses an nPWE signal for another purpose, the PXA250 and 255 processors were changed to use the nWE signal for static memory and the nPWE signal for VLIO. Thus, if these signals from the PXA250 or 255 processors are sent to the connection ports 34 and 36, then a VLIO device would not receive a write strobe. Similarly, if the nPWE signal is connected to the nWE pin, then a static memory device would not receive a write strobe.

Typically, such a signal compatibility problem would require the docking station 31 of the device 30 to be completely redesigned. However, the techniques set forth herein address such a signal compatibility problem in a manner that provides forward compatibility with the new processor for the device 30 designed for the earlier version of the processor 12 without the need for such a costly and time consuming redesign effort. As a result, docking stations 31 designed for use with portable devices 32 having an earlier version of the processor 12 may be used with portable devices 32 having a newer version of the processor 12.

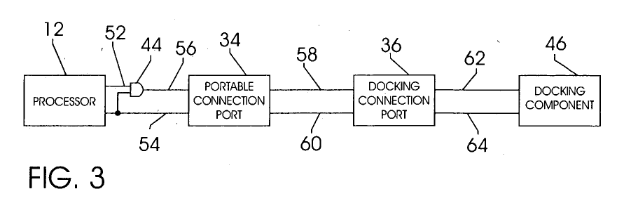

The alleviation of these potential communication problems is explained in FIG. 3. FIG. 3 is a block diagram of a simplified signal path in accordance with an embodiment of the present invention. Again, in this example the processor 12 may be a PXA250 or 255 processor that may deliver a first signal, such as an nWE signal, over a connection 52, and a second signal, such as an nPWE signal, over a connection 54. The first and second signals may be delivered to the logic component 44. In this example, the logic component may comprise an “AND” gate. Because the nWE and nPWE signals are active low signals that are mutually exclusive, the AND gate essentially operates as an OR gate. Thus, the nWE and nPWE signals are combined to match the behavior of the previous processor type, such as a SA-1110. As a result, regardless of which version of the processor 12 is used, the appropriate signals are passed over the connection port 34 to the connection port 36.

Other configurations of the logic component 44 may exist depending on, among other things, the nature and function of the signals that are processed by the logic component 44. Furthermore, the logic component 44 may be located at other places in the electronic device 10 (FIG. 1) based on specific design considerations applicable to the device.

After the logic component 44 performs its function on the first and second signals, the combined signal may be delivered to the connection port 34 via a signal path 56. The second signal may remain unaltered and continue onto the connection port 34 via a connection 54. Within the connection port 34, the connections 54 and 56 may correspond to a first pin and a second pin, respectively. The connection port 34 may deliver the created signal to the connection port 36 of the docking station 31 (FIG. 2) over a connection 58. The second signal may be delivered to the connection port 36 via a connection 60. The connection port 36 may deliver the created signal to the docking component 46 over a connection 62. The second signal may be delivered to the docking component 46 over a connection 64.

While the invention may be applicable to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A circuit, comprising:
a control circuit adapted to receive a plurality of signals, each of the plurality of signals adapted to perform a separate respective function, and to combine the plurality of signals into a single signal adapted to perform each of the separate respective functions.

2. The circuit, as set forth in claim 1, wherein the control circuit comprises a logic gate adapted to receive the plurality of signals and to combine the plurality of signals into the single signal.

3. The circuit, as set forth in claim 2, wherein the logic gate comprises an AND gate.

4. The circuit, as set forth in claim 1, comprising an integrated circuit adapted to produce the plurality of signals.

5. The circuit, as set forth in claim 4, wherein the integrated circuit comprises a processor.

6. The circuit, as set forth in claim 5, wherein the processor comprises one of an Intel PXA250 and PXA255 microprocessor.

7. The circuit, as set forth in claim 1, comprising a connector adapted to receive the single signal.

8. A system comprising:
a device having a first type of processor adapted to produce a plurality of signals, wherein each of the plurality of signals is produced for a different purpose, and having a circuit adapted to combine the plurality of signals into a single signal adapted to accomplish each different purpose; and
a coupling device adapted to connect the device to another device, the coupling device having a connector adapted to receive the single signal but not the plurality of signals.

9. The system, as set forth in claim 8, wherein the device comprises a portable device.

10. The system, as set forth in claim 9, wherein the portable device comprises a pocket PC.

11. The system, as set forth in claim 8, wherein the coupling device comprises a docking station.

12. The system, as set forth in claim 8, wherein the docking station is adapted to be coupled to another portable device having second type of processor.

13. The system, as set forth in claim 12, wherein the first type of processor comprises one of an Intel PXA250 and PXA255 microprocessor, and wherein the second type of processor comprises an Intel SA-1110 microprocessor.

14. A method of coupling a first device to a second device, wherein the first device generates a plurality of signals to perform a plurality of functions, and wherein the second device is adapted to receive a single signal to perform the plurality of functions, the method comprising:
combining a plurality of signals adapted to perform a plurality of functions into a single signal adapted to perform the plurality of functions; and
delivering the single signal from the first device to the second device.

15. The method, as set forth in claim 14, wherein combining comprises transmitting the plurality of signals to a logic circuit, wherein the logic circuit generates the single signal.
